(19) United States
(12) Patent Application Publication
(10) Pub. No.: US 2010/0040751 A1
(43) Pub. Date: Feb. 18, 2010

(54) METHOD FOR PRODUCTION OF BEVERAGE

(75) Inventor: Yasushi Yamada, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KAO CORPORATION, Tokyo (JP)

(21) Appl. No.: 12/513,698

(22) PCT Filed: Oct. 18, 2007
(86) PCT No.: PCT/JP2007/001133

§ 371 Date: May 6, 2009

(30) Foreign Application Priority Data
Nov. 7, 2006 (JP) 2006-301154

(51) Int. Cl. A23F 3/20; A23F 3/16

(52) U.S. Cl. 426/474

(57) ABSTRACT

Provided is a method for production of a beverage, including discharging air bubbles having a median diameter of 1 to 200 μm into a solution containing a tea extract or a tea extract solution and removing a layer of bubbles formed on a surface of the solution. The method enables to produce a beverage containing a tea extract which has a high purity quality and good flavor.

### FIELD OF THE INVENTION

The present invention relates to a method for production of a beverage which contains a tea extract, has a high quality in purity and is excellent in flavor, and also to a packaged beverage produced by application of this method.

### BACKGROUND OF THE INVENTION

Non-polymer catechins are known to have excellent physiological activities, such as a capability of suppressing an increase in cholesterol level and an inhibitory effect on α-amylase activity (e.g. Patent Document 1 and Patent Document 2). In order for these physiological effects to materialize, it is necessary to ingest non-polymer catechins in a certain amount or more. As a packaged beverage designed for such a purpose, a beverage containing a high concentration of non-polymer catechins is known. Examples thereof include a method for keeping the storage stability of a beverage sustainable by adjusting the ratio of non-epicatechins to epicatechins in non-polymer catechins (e.g. Patent Document 3) and a method for enhancing the transparency of a beverage by use of cyclic dextrin (e.g. Patent Document 4).

Meanwhile, a beverage containing a tea extract solution or a tea extract is poor in purity quality, and its commercial value could sometimes be damaged thereby in terms of visual attractiveness. Hence, a beverage that contains a tea extract and is high in purity quality is in demand. Examples of the known methods for enhancing the purity quality include a method for column extraction in which a generation of fine-powdery tea leaves is small (Patent Document 5) and a method for microfiltration such as diatomite filtration (Patent Document 6).
Patent Document 1: JP 60-156614 A
Patent Document 2: JP 03-133928 A
Patent Document 3: JP 2002-142677 A
Patent Document 4: JP 2002-238518 A
Patent Document 5: JP 2000-50799 A
Patent Document 6: JP 04-311348 A

### DISCLOSURE OF THE INVENTION

The present invention provides a method for production of a beverage, which includes discharging air bubbles having a median diameter of 1 to 200 μm into a solvent containing a tea extract or a tea extract solution, and then removing a layer of bubbles formed on a surface of the solution.

### BRIEF DESCRIPTION OF DRAWINGS

FIG. 1 is a diagram schematically illustrating a method for forming fine air bubbles by a compression dissolution method.

### DETAILED DESCRIPTION OF THE INVENTION

None of the conventional methods has been enough to improve the purity quality of a beverage. A method for microfiltration such as diatomite filtration, for example, has such a problem that the intrinsic flavor of tea could weaken over time.

Therefore, the present invention provides a method for production of a beverage containing a tea extract or a tea extract solution, which has a high purity quality and good flavor.

The inventors of the present invention have therefore made a study in order to find a way to improve the purity quality of a tea extract or a tea extract solution without causing a change in flavor and, as a result, found that the purity quality can be improved by forming air bubbles in a solution containing the tea extract solution or the tea extract solution and then removing a layer of bubbles formed on the surface of the solution. From the results of their further study, it has also been found that the improvement of purity quality and a decrease in harsh taste/unpleasant taste can be attained by allowing air bubbles to have a fine median diameter of 1 to 200 μm. Thus, the present invention has been completed.

According to the method of the present invention, a beverage containing a tea extract and having a high purity quality and good flavor can be obtained. The beverage obtained has a high purity quality, so it is useful as a tea beverages or a non-tea beverage (e.g. sports drinks).

In the method of the present invention, first, air bubbles having a median diameter of 1 to 200 μm are discharged into a solution containing a tea extract or a tea extract solution.

Examples of the tea extract solution include solutions which are extracted from tea leaves obtained from the genus Camellia, such as C. sinensis and C. assamica, and hybrids thereof, and subjected to a tea-manufacturing process, by using water, hot water or an aqueous solution added with an extraction aid. The prepared tea leaves include: unfermented teas collectively referred to as green tea, such as Sencha (medium-grade green tea), Bancha (coarse green tea), Gyokuro (refined green tea), Tencha (not powdered tea), and Kamairicha (roasted tea); semi-fermented tea such as oolong tea; and fermented tea such as black tea. The extraction of tea is carried out by a conventional process such as stirring extraction. Water to be used in extraction may be previously added with any salt of organic acids, such as sodium ascorbate, from the standpoint of oxidation stability. Further, there may be used in combination a method for carrying out the extraction under so-called non-oxidative atmosphere while removing dissolved oxygen by means of boiling deaeration or aeration with inert gas such as nitrogen gas.

In addition, examples of the tea extracts include a material prepared by concentrating an extract obtained by extracting tea leaves with water or an aqueous organic solvent, a material prepared by purifying such a concentrated material, or a material prepared by directly purifying the extract per se. The commercially-available products thereof include “Polyphenon” manufactured by Mitsui Norin Co., Ltd., “TEAFURAN” manufactured by ITO EN, LTD., and “SUNPHENON” manufactured by Taiyo Kagaku Co., Ltd., and any of those may be used. As the form of the tea extract used herein, various forms can be mentioned including an aqueous solution and slurry. Examples of the tea extracts of the present invention include the material in which any of the above commercial products is dissolved.

Examples of the solution containing the tea extract or the tea extract solution include a mixture solution of the tea extract and the tea extract solution. Hereinafter, each of those is referred to as tea extract-containing solution. In addition, as the tea extract or the tea extract solution, a green tea extract or a green tea extract solution is preferred.

Air bubbles to be discharged into a tea extract-containing solution are required to have a median diameter of 1 to 200 μm, from the standpoint of improving the purity quality and keeping the good flavor sustainable. For example, as described in JP 2005-176761 A, air bubbles formed by ordinary means for bubbling have diameters of several millimeters to several centimeters. Those large air bubbles form an unstable and breakable bubble layer and take longer treating time, while requiring a large volume of gas. Therefore, a flavor component will be scattered and lost. Besides, an effect of improving the purity quality is not sufficient. If the diameter is smaller than 200 μm, a stable bubble layer is formed. For generating air bubbles smaller than 1 μm, there is a need of an expensive special device. The median diameter of air bubbles is more preferably 3 to 100 μm and even more preferably 5 to 50 μm. The median diameter of air bubbles can be measured by using a batch cell by laser diffractometry (SALD-7100 manufactured by Shimadzu Corporation, etc.).

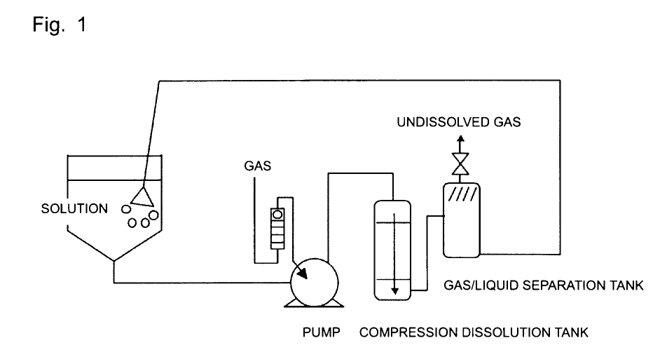

In the present invention, means for discharging air bubbles with a median diameter of 1 to 200 μm into a tea extract-containing solution is not specifically limited as far as such fine air bubbles can be discharged. For instance, there are following conditions: conditions for dissolving a self-suctioned gas on the suction side of a pump into the solution under increased pressure and releasing pressure into the solution through a nozzle (compression dissolution method, see FIG. 1); conditions for causing a rotational flow in a line mixer to causes hearing as a result of running into protrusions, thereby refining an air phase in the center of the shearing flow; conditions for passing an air/liquid mixture phase into a Venturi tube and utilizing an impact wave caused by pressure release; or conditions for pushing air into a solution through fine pores in a Shirasu porous glass membrane under high pressure. Any of those conditions may be used, and of those, the compression dissolution method is preferred because the generation of air bubbles is most abundant.

In addition, gas to be used for discharging air bubbles into a tea extract-containing solution is, but not specifically limited to, preferably carbon dioxide, nitrogen, or any of other inert gas to prevent the solution from quality deterioration by oxygen. Nitrogen is preferred because nitrogen-containing air bubbles have small solubility to beverages and do not remain therein. Besides, the nitrogen concentration in the gas is preferably 95% or more.

Further, the volume of the gas discharged into the tea extract-containing solution is preferably 0.1 to 10% by volume, more preferably 0.2 to 5.0% by volume, and even more preferably 0.2 to 2.0% volume with respect to the tea extract-containing solution in terms of 1 atm at 25° C. Likewise, the number density of air bubbles in the tea extract-containing solution is preferably 10² to 10⁶/cm³ and more preferably 10³ to 10⁵/cm³. The number density of air bubbles can be measured using a particle counter (KS-17A manufactured by RION).

In addition, the position for discharging air bubbles into the tea extract-containing solution is preferably around the bottom part of the solution when contact efficiency between the generated air bubbles and the solution is taken into consideration.

Subsequently, the layer of bubbles formed on the surface of the solution is removed. The removal of the bubble layer can be carried out using operations such as filter filtration, centrifugation, and bubble vacuum operation. Alternatively, as a simple operation, there is an operation in which air bubbles are formed in a tank and then the depth of a solution is controlled when the solution is fed from the bottom of the tank, thereby separating only the bubbles to be left in the tank. Of those, the removal of the bubbles with the solution-depth control is preferable from the standpoint of industrial productivity. The tank described herein may be a tank for extracting a tea extract solution, a mixing tank, or a foaming-removal tank specifically arranged for forming bubbles. The process may be carried out in any kind of tank as far as the tank enables to attain the object of the present invention.

It is preferred to carry out those operations of foaming and removing bubbles at 0 to 80° C. and particularly at 0 to 40° C. from the standpoint of exerting an effect of improving flavor, because the heat history at the time of treatment can be suppressed.

The obtained tea extract-containing solution can be directly provided as a beverage. Alternatively, the solution maybe directly sterilized or sterilized after being diluted, followed by being provided as a packaged tea beverage.

The method of the present invention is preferably employed for a tea beverage containing catechins in high concentration, particularly non-polymer catechins in a dissolved state in an amount of 0.05 to 0.6 mass % from the standpoint of physiological effects and flavor-improving effects.

In the present invention, non-polymer catechins refer to a collective term including non-epicatechins such as catechin, gallocatechin, catechin gallate, and gallocatechin gallate, and epicatechins such as epicatechin, epigallocatechin, epicatechin gallate, and epigallocatechin gallate.

The concentration of the non-polymer catechins, from the standpoint of flavor, is preferably 0.06 to 0.5 mass %, more preferably 0.07 to 0.5 mass %, more preferably 0.08 to 0.5 mass %, more preferably 0.092 to 0.5 mass %, more preferably 0.1 to 0.4 mass %, and even more preferably 0.12 to 0.3 mass %.

In addition, the ratio of generic gallates, which are the non-polymer catechins of the present invention including catechin gallate, epicatechin gallate, gallocatechin gallate, and epigallocatechin gallate, to the entire non-polymer catechins of the present invention is preferably 45 mass % or more from the standpoint of the effectiveness of the physiological effects of the non-polymer catechins.

A container used for the beverage of the present invention can be provided in an ordinary form such as a molded container formed of polyethylene telephthalate as a principal component (so-called PET bottle), a metal can, a paper container combined with metal foils or plastic films, or a bottle. The term “packaged beverage” as used herein means a beverage which can be consumed without being diluted.

Further, in the method of the present invention, it can be produced, for example, by filling in a container such as a metal can and, when heat sterilization is feasible, conducting heat sterilization under sterilization conditions as prescribed in the Food Sanitation Law. For those not suitable for retort sterilization, such as PET bottles or paper containers, there is adopted a method in which the beverage is sterilized beforehand under similar sterilization conditions as those described above, for example, at a high temperature for a short period of time by a plate-type heat exchanger, is cooled to a certain temperature, and is then filled in a container. Under aseptic conditions, additional ingredients may be added to and filled in a filled container.

### Examples

### Example 1

Using a kneader extractor, 144 g of Sencha leaves was added to 4,320 g of ion-exchanged water heated to 65° C., and was subjected to extraction for 5 minutes while being stirred. Tea leaves were removed using a metal net and an extract solution was then cooled to 15° C. Subsequently, filter filtration was carried out using a Zeta Plus 10C manufactured by CUNO K.K. After the filter filtration, a tea extract (23 mass % of non-polymer catechins content) was added, thereby obtaining Preparation A in which the concentration of non-polymer catechins was adjusted to 0.18 mass %.

Using the centrifugal pump M20LD manufactured by NIKUNI Co., Ltd., fine air bubbles of nitrogen were discharged into 15 L of the preparation by a compression dissolution method. The preparation was circulated at a rate of 9.3 L/min and nitrogen was aspirated at a rate of 1.8 L/min. Undissolved nitrogen was removed from the upper part of the separation tank. The nitrogen dissolution pressure was 0.57 MPa and the median diameter of air bubbles was 29 μm. After treating for 20 minutes, air bubbles (2.0 mass %) formed on the surface of the solution was removed. Baking soda was used for adjusting pH to 6.3.

### Comparative Example 1

Preparation A obtained in Example 1 was adjusted to pH 6.3 with baking soda (no treatment of air bubbles).

### Comparative Example 2

Preparation A obtained in Example 1 was subjected to nitrogen bubbling. Nitrogen was introduced at a rate of 1.8 L/min for 10 minutes through a silicon hose with an inner diameter of 4 mm, followed by stirring with a stirrer for 10 minutes, and the bubbles formed on the surface of the solution were removed. The operation was repeated five times. The amount of removed bubbles was 0.8 mass %. The air bubbles immediately floated up to the surface and burst. Thus, the median diameter thereof could not be measured, but the diameter was approximately 8 mm by visual observation. Baking soda was used for adjusting pH to 6.3.

Those analytical values and flavor evaluation results are shown in Table 1. Turbidity was represented by absorbance at 660 nm. Hunter color difference was measured using the color-difference meter ZE-2000 manufactured by Nippon Denshoku Industries, Co., Ltd. Example 1 showed low turbidity, high L value of color difference, and a good degree of purity quality. In addition, there were little harsh taste and unpleasant taste, and the flavor was good. In addition, Comparative Example 2 showed little hash taste, but the flavor thereof was subtle and the purity quality thereof was insufficient. Further, when Example 1 and Comparative Example 1 were sterilized at 138° C. for 30 seconds, Example 1, compared with Comparative Example 1, showed a higher degree of purity quality just as that before the sterilization, and also showed milder heated odor caused by the sterilization and good flavor.

TABLE 1

| | | Comparative | Comparative |
|---|---|---|---|
| | Example 1 | Example 1 | Example 2 |
| Concentration of non-polymer | 0.179 | 0.181 | 0.179 |
| catechins (mass %) | | | |
| pH | 6.28 | 6.27 | 6.30 |
| Turbidity (OD 660 nm) | 0.022 | 0.030 | 0.029 |
| L value of color difference | 92.60 | 91.59 | 91.50 |
| Harsh taste | Little | Much | Little |
| Unpleasant taste | Little | Much | Slightly much |
| Flavor | Good | Good | Little |

### Example 2

Using a column extractor, ion-exchanged water heated to 90° C. was showered on 298 g of oolong tea leaves, thereby obtaining 2,086 g of an extract solution. The extract solution was quickly cooled to 15° C. After filter filtration with the Zeta Plus 50 C manufactured by CUNO K.K., a tea extract (23 mass % of non-polymer catechins content) was added, thereby obtaining Preparation B in which the concentration of a non-polymer catechins was adjusted to 0.13 mass %.

Fine air bubbles of nitrogen were discharged into 15 L of the preparation under the same conditions as those of Example 1. The median diameter of air bubbles was 32 μm. After 20 minutes, bubbles (1.8 mass %) formed on the surface of the solution was removed by filter filtration. Baking soda was used for adjusting pH to 6.3.

### Comparative Example 3

Preparation B obtained in Example 2 was adjusted to pH 6.3 with baking soda (no treatment of air bubbles).

Those analytical values and flavor evaluation results are shown in Table 2. Example 2 showed low turbidity, high L value of color difference, and good purity quality. In addition, there were little harsh taste and unpleasant taste, and the flavor was good.

TABLE 2

| | | Comparative |
|---|---|---|
| | Example 2 | Example 3 |
| Concentration of non-polymer | 0.132 | 0.131 |
| catechins (mass %) | | |
| pH | 6.29 | 6.27 |
| Turbidity (OD 660 nm) | 0.030 | 0.037 |
| L value of color difference | 87.88 | 85.98 |
| Harsh taste | Little | Much |
| Unpleasant taste | Little | Much |
| Flavor | Good | Good |

### Example 3

A non-tea beverage prescribed in Table 3 was obtained as Preparation C. The concentration of non-polymer catechins was adjusted to 0.13 mass %.

Fine air bubbles of nitrogen were discharged into 15 L of the preparation under the same conditions as those of Example 1. The median diameter of air bubbles was 35 μm. After 20 minutes, air bubbles (1.3 mass %) formed on the surface of the solution was removed by filtration.

TABLE 3

| | |
|---|---|
| Sweetener | 0.99 |
| Acidulant | 0.25 |
| NaCl | 0.08 |
| L-ascorbic acid | 0.05 |
| Cyclic oligosaccharide | 0.52 |
| tea extract | 0.85 |
| Fruit juice | 0.10 |
| Flavor | 0.30 |
| Ion-exchanged water | Balance |
| Total | 100 |

### Comparative Example 4

Preparation C obtained in Example 3 was used (no treatment of air bubbles).

Those analytical values and flavore valuation results are shown in Table 4. Example 3 showed low turbidity, high L value of color difference, and good purity quality. In addition, there were little harsh taste and unpleasant taste, and the flavor was good. Further, when Example 3 and Comparative Example 4 were sterilized at 98° C. for 30 seconds, Example 3, compared with Comparative Example 4, showed higher purity quality just as that before the sterilization, and also showed milder heated odor caused by the sterilization and good flavor.

TABLE 4

| | | Comparative |
|---|---|---|
| | Example 3 | Example 4 |
| Concentration of non-polymer | 0.126 | 0.128 |
| catechins (mass %) | | |
| pH | 3.80 | 3.83 |
| Turbidity (OD 660 nm) | 0.222 | 0.230 |
| L value of color difference | 76.98 | 76.54 |
| Harsh taste | Little | Much |
| Unpleasant taste | Little | Much |
| Flavor | Good | Good |

1. A method for production of a beverage, comprising:
discharging air bubbles having a median diameter of 1 to 200 μm into a solution containing a tea extract or a tea extract solution; and
removing a layer of bubbles formed on a surface of the solution.

2. The method for production of the beverage according to claim 1, wherein the discharging air bubbles comprises dissolving a gas into the solution under pressure, and then releasing the gas to an atmospheric pressure.

3. The method for production of the beverage according to claim 1 or 2, wherein the air bubbles contain nitrogen.

4. The method for production of the beverage according to any one of claims 1 to 3, wherein the tea extract solution is a liquid extracted from green tea leaves.

5. The method for production of the beverage according to any one of claims 1 to 4, wherein the beverage is a non-tea beverage.
